(19) United States
(12) Patent Application Publication
(10) Pub. No.: US 2006/0152594 A1
(43) Pub. Date: Jul. 13, 2006

(54) Mobile communication device having call-triggered image taking and sending capability and method of operation thereof

(75) Inventors: Assaf Landschaft, Munich (DE); Gal Wohlstadter, Munich (DE); Gil Wohlstadter, Munich (DE)

Correspondence Address: HITT GAINES P.C., P.O. BOX 832570, RICHARDSON, TX, 75083, US

(73) Assignee: Agere Systems Incoporated, Allentown, PA (US)

(21) Appl. No.: 11/033,204

(22) Filed: Jan. 11, 2005

(51) Int. Cl. H04N 5/232

(52) U.S. Cl. 348/211.99

(57) ABSTRACT

A mobile communication device, a surveillance system and a method of detecting. In one embodiment, the device includes: (1) a camera, (2) a trigger detection circuit associated with the camera and configured to receive an external trigger signal and activate the camera to capture at least a single image therewith and (3) a transmitter associated with the trigger detection circuit and configured to transmit the at least the single image via a wireless network to a receiver.

### TECHNICAL FIELD OF THE INVENTION

The present invention is directed, in general, to monitoring and more particularly to a monitoring system and method using a mobile communication device, which is provided with a camera module.

### BACKGROUND OF THE INVENTION

Today, surveillance systems are used in many areas ranging from security to baby monitoring. A typical type of surveillance system is the close-circuit television (CCTV), which is a television system intended for only a limited number of viewers including at least one dedicated camera monitoring a defined area and a monitor on which the images are displayed. For corporate security purposes, a surveillance system typically is an on-site system with security personnel supervising the monitors which display the images from the connected cameras.

For example, U.S. Patent Application Publication No. 2003/0043279 A1 describes a video surveillance system for providing on-site monitoring with off-site access to video images. The video surveillance system includes an on-site video camera for capturing video images which is operatively connected to a service hub. The service hub includes a video server for converting the video images into wirelessly transmittable digital data. The digital data is then transmitted via a wireless network to an off-site receiver.

Systems used for private surveillance purposes such as monitoring private property are also typically of the closed-circuit television (CCTV)-type including a camera and a monitor connected thereto. Closed-circuit cameras, however, are expensive and complicated to install and use. Furthermore, these systems usually are not flexible, since the camera is installed at a fixed location.

Another private use of surveillance systems is, for example, to monitor a baby. CCTV systems for this purpose are expensive; therefore, audio surveillance systems are far more available.

Accordingly, what is needed in the art is a flexible and easy-to-use surveillance system and to show a new and improved approach to visual monitoring and/or remote tracking.

### SUMMARY OF THE INVENTION

To address the above-discussed deficiencies of the prior art, the present invention provides, in one aspect, a mobile communication device. In one embodiment, the device includes: (1) a camera, (2) a trigger detection circuit associated with the camera and configured to receive an external trigger signal and activate the camera to capture at least a single image therewith and (3) a transmitter associated with the trigger detection circuit and configured to transmit the at least the single image via a wireless network to a receiver. For purposes of the present invention, an “external trigger signal” is one that originates remotely from the device. An external trigger signal can originate from a calling device and be conveyed to the device by a network. An external trigger signal can originate from a moving object or a noise detected by a microphone. An external trigger signal cannot originate at a shutter release button on the device itself or an extension cable of some sort that couples to any shutter release button on the device.

In another aspect, the present invention provides a surveillance system. In one embodiment, the system includes: (1) a first mobile communication device, including: (1a) a camera, (1b) a trigger detection circuit associated with the camera and configured to receive an external trigger signal and activate the camera to capture at least a single image therewith and (1c) a transmitter associated with the trigger detection circuit and configured to transmit the at least the single image via a wireless network to a receiver and (2) a second mobile communication device configured to send its own telephone number when calling the first device.

In yet another aspect, the present invention provides a method of monitoring. In one embodiment, the method includes: (1) detecting an external trigger signal by a first mobile communication device, (2) capturing at least a single image with a camera of the first mobile communication device in response to the external trigger signal and (3) transmitting the at least the single image via a wireless network to a receiver.

The foregoing has outlined preferred and alternative features of the present invention so that those skilled in the art may better understand the detailed description of the present invention that follows. Additional features of the present invention will be described hereinafter that form the subject of the claims of the present invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a schematic view of one embodiment of a mobile communication device constructed according to the principles of the present invention;

FIG. 2 illustrates a schematic view of one embodiment of a surveillance system including a first and a second mobile communication device and constructed according to the principles of the present invention; and

FIG. 3 illustrates a flow diagram of one embodiment of a method of monitoring carried out according to the principles of the present invention.

### DETAILED DESCRIPTION

As stated above, the present invention proposes a mobile communication device, in particular a mobile telephone, a PDA or a MDA, that, in one embodiment, includes a camera, a means for detecting an external trigger signal, a means for capturing at least a single image (perhaps a series of images constituting a video sequence) with the camera, and a means for transmitting captured image data via a wireless network to a receiver. The mobile communication device is adapted to automatically capture and transmit a single image or a video sequence in response to a detected external trigger signal. The present invention thereby enables a remote user located at the position of the receiver to visually monitor an object or person located at the position of the inventive mobile communication device. The present invention can be used for conventional or later-developed mobile telephones as well as PDA- or MDA-style devices.

Present 2.5G mobile communication devices usually are provided with a camera but are typically only adapted for capturing of still images. However, 3G mobile communication devices also support streaming video, whereby the present invention provides the full functionality of a CCTV system. The illustrated embodiment of an inventive device, which is adapted to capture a video sequence or video stream can also be used for remote video tracking, such as, for example, remotely supervising a police operation or video tracking such operation for evidence purposes.

The terms “2.5G” and “3G” with respect to wireless technology stand for “second and a half generation” and “third generation” respectively. Usually, UMTS (Universal Mobile Telecommunication Service) is identified as 3G, providing enhanced multimedia functionality, broad bandwidth and high speed. 2.5G provides some of the benefits of 3G and commonly includes the GPRS protocol.

The device may be triggered by a remote user by sending an according external trigger signal to the device using a second mobile communication device, wherein the second device advantageously also is the receiver of the captured image data. As an alternative trigger generation, the device may be provided with means for detecting movement in the field of view of the camera, for example including an infrared sensor. That way, for example, whenever a movement is detected an image is captured with the camera and transmitted to the receiver.

To allow remote triggering, the means for detecting an external trigger signal may include a memory unit for storing at least one telephone number, a means for detecting the telephone number of a calling device from the data of an incoming call and a means for comparing the detected telephone number with the at least one telephone number stored in the memory unit; the latter two means may be embodied in an identification circuit. The device is thus configured to automatically capture a single image or a video sequence in response to an incoming call from a calling device the telephone number of which matches a telephone number stored in the memory unit of the device and to automatically transmit captured image data via a wireless network to a receiver.

The device may further include a microphone for capturing audio data, allowing the device to transmit captured audio data via the wireless network. The device may further be provided with a sound sensor, which can be used as a further alternative trigger generator.

The transmission of the captured image and/or audio data may be performed by means of an e-mail or a multimedia message according to MMS (Multimedia Messaging System) standards. The present invention, of course, is not limited to these protocols, but also encompasses any other suitable conventional or later-developed transmission protocol.

A surveillance system also lies within the scope of the present invention. One embodiment of the surveillance system includes a first mobile communication device as described above and a second mobile communication device having a display. The second device may be adapted to send its own telephone number when calling the first device and provided with a display to display image data received from the first device.

The present invention further encompasses a method for monitoring, including detecting an external trigger signal by a first mobile communication device, capturing a single image or a video sequence with a camera of the first mobile communication device in response to the detected external trigger signal and transmitting the captured image data via a wireless network to a receiver.

the detecting may include storing the telephone number of at least one second mobile communication device in a memory of the first device, initiating a call from a second device to the first device, detecting the telephone number of the second device by the first device and comparing the detected telephone number with at least one telephone number stored in a memory of the first device. The first device may be triggered when the detected telephone number matches a telephone number stored in the memory of the first device. The second device may be the receiver.

In other words, a first mobile communication device provided with a camera and the number of a second mobile communication device. When the second device calls the first device, the first device recognizes it and, instead of answering the call, automatically activates the camera, captures a picture and transmits it, preferably via e-mail or MMS, to a pre-defined target receiver, which typically is the second device.

Especially for the purpose of visual monitoring of private property, such as monitoring a house while the owner is away, the detecting of the external trigger signal may include detecting movement in the field of view of the camera of the first device.

For certain applications, it may be advantageous to augment the method by capturing audio data by means of a microphone integrated in the first device and transmitting the captured audio data along with the image data via the wireless network to the receiver. Especially for the purpose of parents monitoring their baby, the audio data may be used to trigger the capturing and transmitting of image and/or audio data, so that when the baby wakes up an image or video sequence is automatically sent to the parents.

The transmitting of the captured image and/or audio data may include transmitting an e-mail message and/or a multimedia message according to MMS (Multimedia Messaging System) standards. If an e-mail message is used for transmitting the captured data, a computer can advantageously be used as receiver.

A mobile communication device which is provided with a camera typically is also provided with appropriate application programming interfaces (APIs) for controlling the camera. Also, the device typically is provided with APIs for sending pictures via the GSM/GPRS or UMTS network, depending on the type of device. Furthermore, existing devices already are adapted to recognize an incoming call telephone number and execute some functionality based on it, such as for example displaying the name of the caller from the integrated telephone book. Therefore, the new functionality provided by the present invention can be implemented in a straightforward way by means of a software which uses the existing APIs.

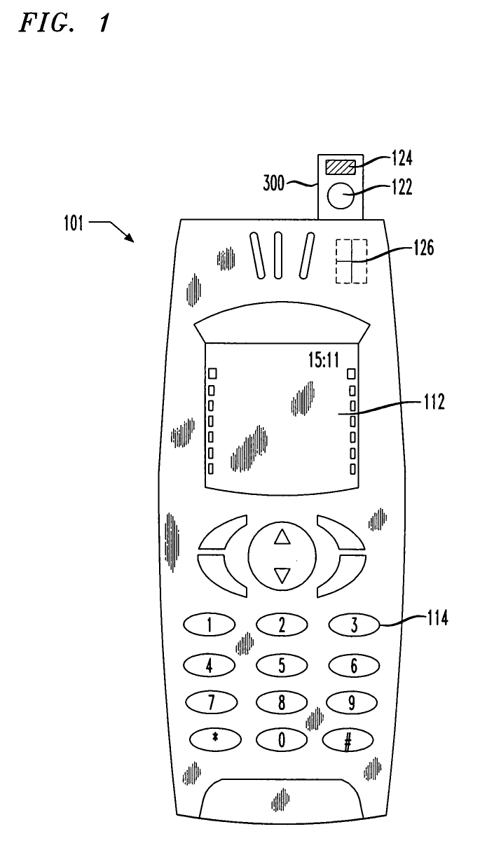

Having described various aspects of the present invention in general, reference is now made to FIG. 1, which illustrates a schematic view of one embodiment of an inventive mobile communication device that takes the form of a mobile telephone 101. The mobile telephone 101 is provided with a camera module 300, which in this embodiment includes a lens 122 and a flash 124. Since conventional mobile telephones may be used for the present invention, the mobile telephone 101 naturally includes standard components such as a display 112 and a keypad 114. The mobile telephone 101 also includes within its main body a cluster of electronic circuits 126 directed to providing functionality to support the illustrated embodiment of the present invention. More specifically, the electronic circuits 126 include a trigger detection circuit, a transmitter, a movement detection circuit and an identification circuit.

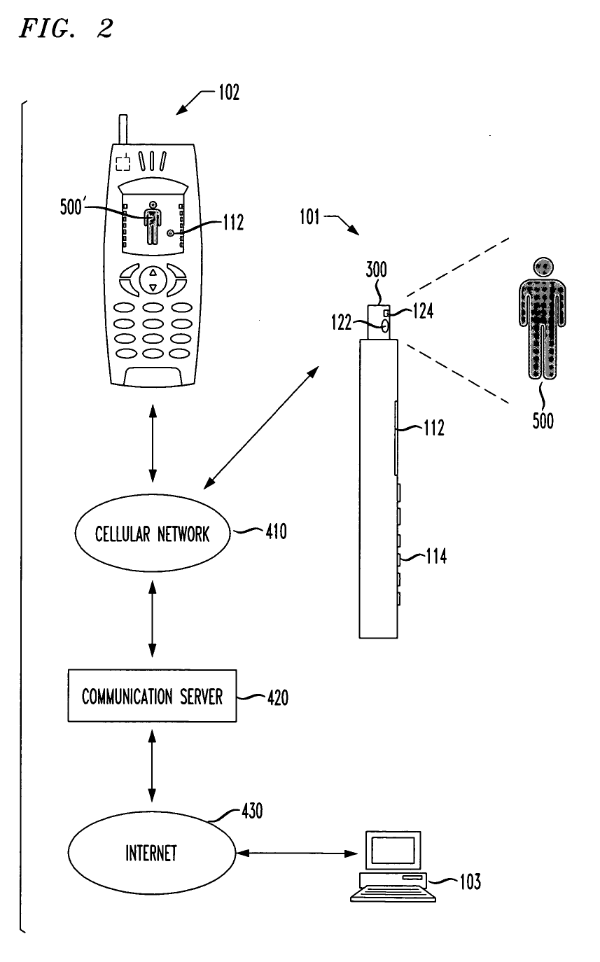

Turning now to FIG. 2, illustrated is a schematic view of one embodiment of a surveillance system including a first and a second mobile communication device and constructed according to the principles of the present invention. The mobile telephone 101, shown in detail in FIG. 1, receives an external trigger signal via the cellular network 410. In this embodiment the external trigger signal is provided by an incoming call from a second mobile telephone 102, which sends its telephone number along with other conventional calling data via a cellular network 410. Alternatively, a detector integrated in the mobile telephone 101 such as, for example, a movement or sound sensor serving as a trigger generator, also lies within the scope of the present invention.

In response to the received external trigger signal, the mobile telephone 101 captures an image of an object or a person 500 by means of the integrated camera module 300. The captured image data is then transmitted back to the mobile telephone 102 and there the image 500′ of the monitored object or person is visualized on display 112. For this purpose, the transmission of the captured image data may be performed by means of a multimedia message according to MMS standards or by means of an e-mail message.

Alternatively the captured image data can also be transmitted as an e-mail message via the cellular network 410, communication server 420 and the Internet 430 to a computer 103. The image data can then be visualized on a monitor connected to computer 103.

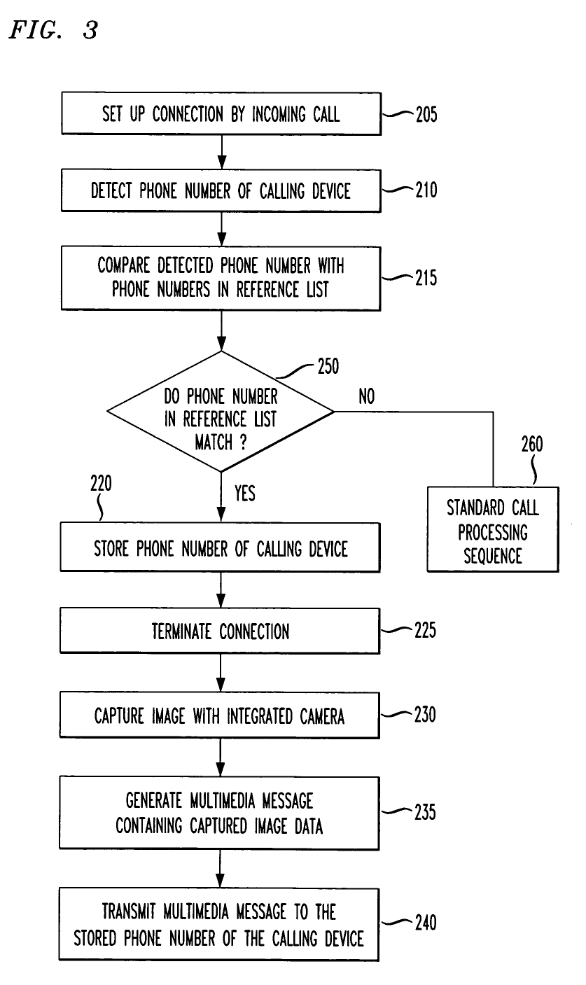

Turning now to FIG. 3 and with continuing reference to FIG. 2, illustrated is a flow diagram of one embodiment of a method of monitoring carried out according to the principles of the present invention.

First, a connection set-up is initiated in a step 205 by a mobile telephone 102 calling mobile telephone 101, wherein mobile telephone 102 sends its telephone number. The telephone number of the calling device is detected in a step 210 by the mobile telephone 101, the calling device being mobile telephone 102. In the mobile telephone 101, a reference list with telephone numbers is stored, which is provided by the user prior to the course of actions shown in FIG. 3. In the illustrated embodiment, only a calling device having a telephone number included in the reference list is authorized to remotely activate the capturing of images. Accordingly, the telephone number detected by the mobile telephone 101 is compared with the telephone numbers stored in the reference list 215.

If no matching telephone number is found in the reference list in a step 250, a standard call processing sequence is performed in a step 260.

If however a matching telephone number is found in reference list 250, the detected telephone number of the calling device is temporarily stored in a step 220. Since no normal communication is intended, the connection between the mobile telephone 101 and mobile telephone 102 is terminated in a step 125 by the mobile telephone 101. Then an image is captured in a step 230 with the integrated camera of the mobile telephone 101. In the particular embodiment of FIG. 3, a multimedia message according to MMS standards is generated, which contains the captured image data 235. This generated multimedia message is then transmitted in a step 240 to the calling device, namely the mobile telephone 102, by means of the temporarily stored telephone number of the calling device.

It is apparent that the usage of the present invention is straightforward. As just one example, parents who want to monitor their baby while they are out, for example, only have to place a camera-phone near his bed and configure it to send pictures when getting a call from their second mobile telephone. When they want to see whether the baby is well, they only need to call the telephone at home, and after a few seconds they get an up-to-date image or video, depending on the telephones used.

Although the present invention has been described in detail, those skilled in the art should understand that they can make various changes, substitutions and alterations herein without departing from the spirit and scope of the present invention in its broadest form.

What is claimed is:

1. A mobile communication device, comprising:
a camera;
a trigger detection circuit associated with said camera and configured to receive an external trigger signal and activate said camera to capture at least a single image therewith; and
a transmitter associated with said trigger detection circuit and configured to transmit said at least said single image via a wireless network to a receiver.

2. The device as recited in claim 1 wherein said device is selected from the group consisting of:
a mobile telephone,
a personal digital assistant, and
a mobile digital assistant.

3. The device as recited in claim 1 wherein said trigger detection circuit receives said external trigger signal from a selected one of:
said wireless network, and
a movement detection circuit configured to detect movement about said camera.

4. The device as recited in claim 1 wherein said trigger detection circuit comprises:
a memory unit for storing at least one telephone number,
an identification circuit coupled to the memory circuit and configured to compare a telephone number of a calling device with said at least one telephone number and cause said device to capture at least said single image in response thereto.

5. The device as recited in claim 4 wherein said receiver is said calling device.

6. The device as recited in claim 2 wherein said movement detection circuit is configured to detect movement in a field of view of said camera.

7. The device as recited in claim 1 further comprising a microphone configured to capture audio data, said device being further configured to transmit said audio data via said wireless network to said receiver.

8. The device as recited in claim 1 wherein said transmitter is configured to transmit said at least said single image as part of a selected one of:
an e-mail message, and
a multimedia message according to Multimedia Messaging System standards.

9. A surveillance system, comprising:
a first mobile communication device, including:
a camera,
a trigger detection circuit associated with said camera and configured to receive an external trigger signal and activate said camera to capture at least a single image therewith, and
a transmitter associated with said trigger detection circuit and configured to transmit said at least said single image via a wireless network to a receiver; and
a second mobile communication device configured to send its own telephone number when calling said first device.

10. The system as recited in claim 9 wherein said first device is selected from the group consisting of:
a mobile telephone,
a personal digital assistant, and
a mobile digital assistant.

11. The system as recited in claim 9 wherein said trigger detection circuit receives said external trigger signal from a selected one of:
said wireless network, and
a movement detection circuit configured to detect movement about said camera.

12. The system as recited in claim 9 wherein said trigger detection circuit comprises:
a memory unit for storing at least one telephone number,
an identification circuit coupled to the memory circuit and configured to compare said its own telephone number said at least one telephone number and cause said device to capture at least said single image in response thereto.

13. The system as recited in claim 12 wherein said receiver is said second device.

14. The system as recited in claim 10 wherein said movement detection circuit is configured to detect movement in a field of view of said camera.

15. The system as recited in claim 9 wherein said first device further includes a microphone configured to capture audio data, said first device being further configured to transmit said audio data via said wireless network to said receiver.

16. The system as recited in claim 9 wherein said transmitter is configured to transmit said at least said single image as part of a selected one of:
an e-mail message, and
a multimedia message according to Multimedia Messaging System standards.

17. A method of monitoring, comprising:
detecting an external trigger signal by a first mobile communication device;
capturing at least a single image with a camera of said first mobile communication device in response to said external trigger signal; and
transmitting said at least said single image via a wireless network to a receiver.

18. The method as recited in claim 17 wherein said first device is selected from the group consisting of:
a mobile telephone,
a personal digital assistant, and
a mobile digital assistant.

19. The method as recited in claim 17 wherein said detecting comprises receiving said external trigger signal from a selected one of:
said wireless network, and
a movement detection circuit configured to detect movement about said camera.

20. The method as recited in claim 17 wherein said detecting comprises:
storing at least one telephone number;
comparing a telephone number of a calling device with said at least one telephone number; and
causing said device to capture at least said single image in response thereto.

21. The method as recited in claim 20 wherein said receiver is said calling device.

22. The method as recited in claim 18 wherein detecting comprises detecting movement in a field of view of said camera.

23. The method as recited in claim 17 further comprising:
capturing audio data; and
transmitting said audio data via said wireless network to said receiver.

24. The method as recited in claim 17 wherein said transmitting comprises transmitting said at least said single image as part of a selected one of:
an e-mail message, and
a multimedia message according to Multimedia Messaging System standards.
